(19) United States
(12) Patent Application Publication
(10) Pub. No.: US 2018/0366692 A1
(43) Pub. Date: Dec. 20, 2018

(54) FILM MATERIAL FOR BATTERY SHEATHING AND FLEXIBLE BATTERY INCLUDING THE SAME

(71) Applicant: Panasonic Intellectual Property Management Co., Ltd., Osaka (JP)

(72) Inventors: Tomohiro UEDA, Osaka (JP); Yuya ASANO, Osaka (JP)

(21) Appl. No.: 16/060,694

(22) PCT Filed: Dec. 15, 2016
(86) PCT No.: PCT/JP2016/005135

§ 371 Date: Jun. 8, 2018

(30) Foreign Application Priority Data
Dec. 25, 2015 (JP) 2015-252934

(51) Int. Cl. H01M 2/02; B32B 15/088; B32B 15/09; B32B 15/085; B32B 15/20

(52) U.S. Cl. CPC H01M 2/0287; H01M 2/026; B32B 15/088; B32B 2457/10; B32B 15/085; B32B 15/20; H01M 2002/0297; B32B 15/09

(57) ABSTRACT

This film material for battery sheathing includes a gas barrier layer and also a seal layer superposed on one side of the gas barrier layer and containing a first resin. The film material has anisotropic tensile strength, and the tensile strength A at 5% elongation in a first direction, the direction in which the film material has the smallest tensile strength, and the tensile strength B at 5% elongation in a second direction, the direction perpendicular to the first direction, satisfy A/B≤0.95.

### TECHNICAL FIELD

The present invention relates to a film material for flexible battery sheathing and a flexible battery including a sheath fabricated using the film material.

### BACKGROUND ART

In recent years, a battery housed in a flexible sheath has been used as a power supply for small devices such as cellphones, sound recorder-reproducers, watches, still and video cameras, liquid-crystal displays, pocket calculators, IC cards, temperature sensors, hearing aids, pressure-sensitive buzzers, and on-body devices. The flexible sheath is made from a film material including a gas barrier layer and a plastic seal layer. The gas barrier layer functions to reducing components in the air from entering the battery. A suitable material for the gas barrier layer is foil.

Typical fabrication of a flexible sheath includes a step of molding a film material including an aluminum foil as a gas barrier layer and a seal layer (see PTL 1). In relation to this, it has been proposed to make the aluminum foil conform adequately to the mold shape during molding by increasing the 0.2%-offset yield strength to 55 N/mm² or more (see PTL 2).

### CITATION LIST

### Patent Literature

PTL 1: Japanese Published Unexamined Patent Application No. 2006-228653

PTL 2: Japanese Published Unexamined Patent Application No. 2015-106528

### SUMMARY OF INVENTION

As in PTL 1 and 2, known film materials for battery sheathing need to be flexible enough to be suitable for molding. However, since deforming a battery itself may greatly affect the battery performance, there are few reports assuming local bending of a battery itself.

Nevertheless, recent years have seen the development of electronic devices as thin as approximately 2 mm or less. For example, on-body devices such as iontophoresis transdermal drug delivery systems are expected to deform greatly and frequently to follow the movement of the living body. As a result, the demand is increasing for a thin flexible battery.

Since a flexible battery has only a thin space for housing an electrode assembly therein, the fabrication of its sheath does not require greatly deforming a film material using a mold. However, when the battery itself is bent frequently, the gas barrier layer needs to be more durable than can conform to the mold shape during molding.

An aspect of the present disclosure relates to a film material for battery sheathing. The film material includes a gas barrier layer and also a seal layer superposed on one side of the gas barrier layer and containing a first resin. The film material has anisotropic tensile strength, and the tensile strength A at an elongation of 5% in a first direction, in which the film material has a smallest tensile strength, and the tensile strength B at an elongation of 5% in a second direction, perpendicular to the first direction, satisfy

A/B≤0.95.

Another aspect of the present disclosure relates to a flexible battery. The flexible battery includes an electrode assembly including a positive electrode, a negative electrode, and an electrolyte layer interposed between the positive and negative electrodes, and also includes a sheath enclosing the electrode assembly hermetically. The sheath includes the above film material for battery sheathing.

The present disclosure provides a flexible battery that can be frequently bent with limited deterioration of a gas barrier layer of its sheath.

### BRIEF DESCRIPTION OF DRAWINGS

FIG. 1 is a cross-sectional view of the layer structure of a film material according to an embodiment of the present invention for battery sheathing.

FIG. 2 is a cross-sectional view of the layer structure of a film material according to another embodiment of the present invention for battery sheathing.

FIG. 3 is a partially cutaway plan view of the sheath of a flexible battery according to an embodiment of the present invention.

FIG. 4 is a cross-section of the same flexible battery viewed in the direction of arrows IV-IV.

### DESCRIPTION OF EMBODIMENTS

According to this embodiment, a film material for battery sheathing (hereinafter also simply referred to as a film material) includes a gas barrier layer and also a seal layer superposed on one side of the gas barrier layer and containing at least one first resin.

The film material has anisotropic tensile strength, and the tensile strength A at 5% elongation in a first direction, the direction in which the film material has the smallest tensile strength, and the tensile strength B at 5% elongation in a second direction, the direction perpendicular to the first direction, satisfy A/B≤0.95. To provide a flexible battery better in the durability of the gas barrier layer, it is preferred that A/B≤0.82 be satisfied, more preferably A/B≤0.75.

The tensile strengths A and B are both tensile strengths measured as per the tensile test method set forth in JIS K7161 using a sample cut out of the film material. Specifically, the film material is cut into a tensile-test No. 3 dumbbell with a reduced-section width of 5 mm and a gauge length of 60 mm, a tensile test is performed using a universal tester at an elongation rate of 5 mm/min as directed in JIS K7161, and the modulus of elasticity in tension is determined.

By using a sheath having an A/B ratio of 0.95 or less, 0.82 or less, or 0.75 or less, the gas barrier layer is rendered less likely to crack when the flexible battery is bent, for example in an arc along the first direction. The reason why is unclear, but when the film material has a sufficiently small tensile strength A in the first direction and a certain level of tensile strength B in the second direction, the stress applied to the gas barrier layer is relaxed in the first direction. This prevents, the inventors believe, extensive fatigue of the metal forming the gas barrier layer, making the gas barrier layer less likely to crack.

When it comes to ensuring sufficient durability of the gas barrier layer should the film material be stretched in the second direction, the tensile strengths A and B preferably satisfy 0.25≤A/B, more preferably 0.50≤A/B.

The tensile strength A of the film material is preferably 25 N/mm² or less, or 20 N/mm² or less, more preferably 10 N/mm² or less. The condition of the tensile strength A being 25 N/mm² or less helps make the A/B ratio sufficiently small. Such a condition also ensures that even when the flexible battery is bent greatly and frequently in an arc along the first direction, the gas barrier layer is unlikely to crack owing to a small resistance to bending. To ensure sufficient strength of the sheath formed, the tensile strength A of the film material is preferably 3 N/mm² or more.

The tensile strength of the film material depends greatly on the tensile strength of the gas barrier layer. To obtain a film material that satisfies A/B≤0.95, therefore, it is desirable to render the gas barrier layer similarly anisotropic in tensile strength in the first and second directions.

That is, the tensile strength X of the gas barrier layer at 5% elongation in the first direction and the tensile strength Y at 5% elongation in the second direction desirably satisfy that X/Y≤0.93, X/Y≤0.80, or X/Y≤0.70, more desirably 0.1≤X/Y or 0.2≤X/Y.

The tensile strength X of the gas barrier layer is preferably 30 N/mm² or less, more preferably 15 N/mm² or less. The condition of the tensile strength X being 30 N/mm² or less helps make the X/Y ratio sufficiently small. At the same time, the tensile strength X of the gas barrier layer is preferably 1.0 N/mm² or more.

The gas barrier layer desirably includes at least a metal layer, and the gas barrier layer as a whole may be a metal layer. The gas barrier layer may include a metal layer and an oxide layer on at least one side thereof.

The oxide layer may contain a metal oxide or a metalloid oxide. The oxide layer gives the gas barrier layer chemical resistance (e.g., acid resistance). Examples of metals or metalloids used in the oxide layer include chromium (Cr), aluminum (Al), silicon (Si), magnesium (Mg), cerium (Ce), titanium (Ti), molybdenum (Mo), tungsten (W), and zirconium (Zr).

To achieve high flexibility, the metal layer preferably contains at least one selected from group 1 of elements consisting of aluminum, tin (Sn), indium (In), magnesium, bismuth (Bi), cadmium (Cd), and calcium (Ca), desirably with 90% by mass or more of the metal layer represented by group-1 element(s). It is particularly preferred that the metal layer contain at least one selected from group 2 of elements consisting of aluminum, tin, indium, and magnesium, desirably with 90% by mass or more of the metal layer represented by group-2 element(s).

The metal layer desirably includes at least rolled foil and may be a multilayer foil including rolled foil and a deposited metal film. The deposited metal film can be, for example, a vapor deposited film, sputtered film, or plating film. In particular, it is more desirable that the metal layer as a whole be rolled foil. When the gas barrier layer contains rolled foil, the first direction of the film material usually coincides with the direction of rolling of the rolled foil. Any desired anisotropy can therefore be given to the tensile strength of the gas barrier layer by controlling the direction of rolling of the rolled foil. It is also easy to control the degree of anisotropy of the gas barrier layer (i.e., X/Y ratio and accordingly the A/B ratio) by adjusting the pressure applied in the direction of thickness of the foil during rolling.

The rolled foil may be a single layer or a multilayer clad foil. When being a single layer, the rolled foil may be pure-metal foil, containing only a single element, or alloy foil. It should be noted that the pure-metal foil may contain 10% by mass or less impurities. When the rolled foil is clad foil, the directions of rolling coincide between the multiple layers. Each layer of the clad foil may be a pure-metal layer or alloy layer.

To obtain a gas barrier layer especially good in flexibility, it is desirable that 99% by mass or more of a single-layer or multilayer rolled foil be represented by at least one selected from group 3 of elements consisting of tin, indium, and magnesium. In particular, tin desirably represents 90% by mass or more of the rolled metal foil because of its affordability and excellent flexibility.

The thickness T₀ of the gas barrier layer is preferably 10 μm or more, more preferably 20 μm or more, to provide durability. This helps ensure the gas barrier capability (ability to reduce components in the air from entering the battery) and improve the durability of the gas barrier layer. When it comes to making the film material highly flexible, the thickness T₀ of the gas barrier layer is preferably 1800 μm or less, more preferably 500 μm or less, even more preferably 100 μm or less. Any thickness T₀ of the gas barrier layer can be selected considering the balance between the gas barrier capability, flexibility, and durability.

When the gas barrier layer includes rolled foil, the thickness T₁ of the rolled foil is preferably 80% or more of the thickness T₀ of the gas barrier layer, more preferably 90% or more, and may even be 100% (T₁=T₀). The condition of rolled foil representing 80% or more of the thickness of the gas barrier layer helps give the gas barrier layer and film material anisotropic tensile strength.

When the gas barrier layer includes an oxide layer, the thickness T₂ of the oxide layer is desirably less than 20% of the thickness T₀ of the gas barrier layer, more desirably less than 10%, to ensure the flexibility of the sheath. More specifically, the thickness T₂ is preferably between 0.01 to 10 μm, more preferably between 0.05 and 5 μm. It should be noted that a nonaqueous electrolyte battery can produce a strongly acidic substance inside. Among oxide layers, therefore, a chromium oxide (chromate) layer is particularly preferred because of its high acid resistance.

The seal layer, which contains a first resin, is desirably a biaxially oriented resin film, which combines sealing properties and flexibility, preferably with the MD direction (machine direction) of the seal layer substantially parallel to the first direction. Being substantially parallel means that the angle between the MD direction of the seal layer and the first direction is 0° or more and 30° or less (preferably 10° or less). In that case, the direction in which the gas barrier layer has the smallest tensile strength (when the gas barrier layer includes rolled foil, this direction is usually the direction of rolling of the foil) and the MD direction are almost in alignment, which further reduces the resistance to bending that occurs when the flexible battery is bent in an arc along the first direction. The first resin is desirably good in chemical resistance because it comes into contact with an electrolyte, more desirably good in hot melt bonding and sealing properties as well.

The film material may further include a protective layer superposed on the other side of the gas barrier layer and containing at least one second resin. This further improves the durability of the sheath. The protective layer is desirably a biaxially oriented resin film, which combines strength and flexibility. For the same reason as above, the MD direction (machine direction) of the protective layer and the first direction are also preferably substantially parallel, and the angle between the MD direction (machine direction) of the protective layer and the first direction is desirably 0° or more and 30° or less (preferably 10° or less). In that case, the direction in which the gas barrier layer has the smallest tensile strength, the MD direction of the seal layer, and the MD direction of the protective layer are almost in alignment. The second resin is desirably good in abrasion resistance as well as chemical resistance.

The first resin preferably includes a polyolefin, which is good in hot melt bonding properties, preferably with the polyolefin representing 90% by mass or more of the seal layer. The second resin preferably includes at least one selected from the group consisting of polyolefins, polyamides, and polyesters. Making the protective layer with 90% by mass or more polyolefin is preferred because this further reduces the tensile strength of the film material.

Examples of polyolefins include polyethylene (PE) and polypropylene (PP). Examples of polyesters include polyethylene terephthalate (PET) and polybutylene terephthalate (PBT). Examples of polyamides (PA) include polyamide 6, polyamide 11, polyamide 12, polyamide 46, polyamide 9T, and polyamide 66.

In particular, the protective layer is preferably made using PE. This further reduces the tensile strength of the film material.

The seal and protective layers may have any thickness, but an example is any thickness between 10 μm and 100 μm, preferably between 15 μm and 80 μm.

Each of the seal and protective layers may be a single layer or include multiple layers. For example, the seal layer may have a structure such as the two-layer structure of PP/PET or the two-layer structure of PE/PA. The protective layer may have a structure such as the two-layer structure of PE/PET.

The film material can be obtained by, for example, attaching the gas barrier layer to one side of the seal layer. The side of the gas barrier layer not in contact with the seal layer may be covered with a protective layer. In that case, an adhesive agent may be interposed between the gas barrier and seal layers and/or between the gas barrier and protective layers.

For example, stacking a film that contains a first resin to serve as a seal layer and a gas barrier layer that includes rolled foil and then pressing the two layers, for example using a roller, while heating them at 80° C. to 150° C. joins the two layers together. It is more preferred that the direction of rolling of the rolled foil be aligned with the machine direction of the roller, but since the pressure used to form the rolled foil is much larger than that used to join the resin film and rolled foil together, it is not necessarily required to align the direction of rolling with the machine direction of the roller. Alternatively, stacking a film that contains a first resin to serve as a seal layer, a film that contains a second resin to serve as a protective layer, and a gas barrier layer that includes rolled foil, with the gas barrier layer between the two films, and then pressing the three layers while heating them in the same way joins the three layers together. Desirably, the direction of rolling of the gas barrier layer is set substantially parallel to the MD direction of the seal and protective layers. It is also possible to attach the gas barrier layer to one side of the protective layer and then cover with the seal layer the side of the gas barrier layer not in contact with the protective layer.

The thickness of the film material is between 30 μm and 2000 μm for example, preferably between 30 μm and 600 μm, preferably between 30 μm and 240 μm, in particular between 40 μm and 200 μm. This helps obtain a sheath that combines flexibility and durability.

A flexible battery according to the present invention includes an electrode assembly including a positive electrode, a negative electrode, and an electrolyte layer interposed between the positive and negative electrodes, and also includes a sheath enclosing the electrode assembly hermetically. The sheath is made from an above-described film material. Such a flexible battery can be made highly flexible. The sheath can be in any shape. For example, it has a predetermined envelope- or bag-like shape.

The electrode assembly of the flexible battery can be a sheet-shaped multilayer body in which the positive electrode, negative electrode, and electrolyte layer are stacked each in the shape of a sheet. Such a multilayer body can be easily formed thin. The thickness of the battery (total thickness of the electrode assembly and the sheath housing it) can therefore be, for example, 2 mm or less, or even 1 mm or less. This makes the flexible battery highly flexible. It should be noted that an envelope- or bag-shaped sheath has a thickness of two sheets of the film material.

When the electrode assembly is a sheet-shaped multilayer body in a shape having major and minor lengths, i.e., rectangular or substantially rectangular, it is desirable that the length x1 of the electrode assembly in the first direction be set larger than the length x2 of the electrode assembly in the second direction. This is because a flexible battery in a shape having major and minor lengths is designed assuming that its major length will be bent in an arc. Being substantially rectangular means that the positive and negative electrodes have a near-rectangular tetragonal shape when the electrode assembly is viewed in the direction perpendicular to its plane direction. Near-rectangular tetragonal shapes are shapes that can practically be treated as a rectangle, such as distorted rectangles, trapezoids, and parallelograms, and also include shapes rounded or chamfered at the four corners.

The flexible battery may be a primary or secondary battery. Moreover, the battery may be a nonaqueous or aqueous electrolyte battery.

The following describes preferred embodiments of the present invention with reference to the drawings, but the present invention is not limited to these embodiments.

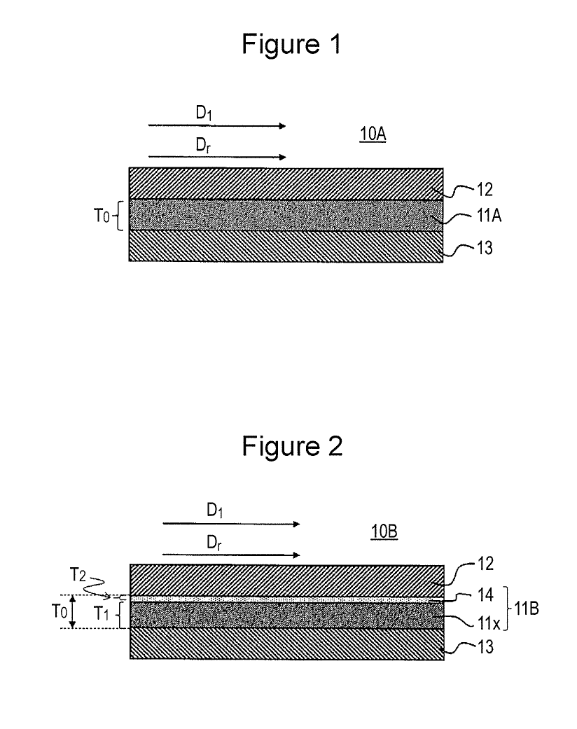

FIG. 1 is a cross-sectional view of the layer structure of a film material according to Embodiment 1 of the present invention.

The film material 10A includes a gas barrier layer 11A having a thickness of T₀, a seal layer 12 superposed on one side of the bas barrier layer 11A, and a protective layer 13 superposed on the other side of the gas barrier layer 11A. The gas barrier layer 11A is, for example, a single-layer rolled foil, in which case the thickness T₁ of the rolled foil is equal to T₀.

FIG. 2 is a cross-sectional view of the layer structure of a film material according to Embodiment 2 of the present invention.

The gas barrier layer 11B of the film material 10B includes a metal layer 11x, which is rolled foil for example, and a metal oxide layer 14 covering the surface of the metal layer 11x. The total of the thickness T₁ of the rolled foil and the thickness T₂ of the metal oxide layer 14 is equal to the thickness T₀ of the gas barrier layer.

The film materials 10A and 10B have anisotropic tensile strength, and the first direction (Dₗ), in which they have the smallest tensile strength, coincides with the direction of rolling (Dᵣ) of the rolled foil that the gas barrier layers 11A and 11B can include.

The seal layer 12 of the film materials according to Embodiments 1 and 2 contains a first resin, and the protective layer 13 contains a second resin. The seal layer 12 and protective layer 13 are, for example, biaxially oriented resin films, and the MD direction of the seal layer 12 and protective layer 13 is substantially parallel to the first direction.

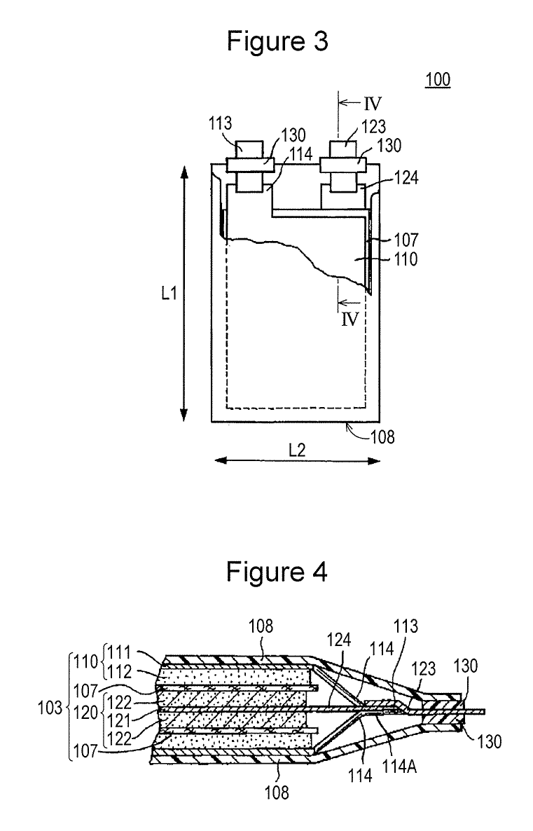

The following describes an example of a battery that includes a sheath made from an above-described film material. FIG. 3 is a partially cutaway plan view of the sheath of a flexible battery according to this embodiment. FIG. 4 is a cross-section of the same flexible battery viewed in the direction of arrows IV-IV. One of first and second electrodes is a positive electrode, and the other is a negative electrode.

The flexible battery 100 includes an electrode assembly 103, an electrolyte (not illustrated), and a sheath 108 enclosing them. The electrode assembly 103 includes a pair of first electrodes 110 located outboard, a second electrode 120 disposed therebetween, and separators 107 interposed between the first electrodes 110 and the second electrode 120. Each first electrode 110 includes a first collector sheet 111 and a first active material layer 112 adhering to one side thereof. The second electrode 120 includes a second collector sheet 121 and second collector layers 122 adhering to both sides thereof. The pair of first electrodes 110 are arranged with the second electrode 120 therebetween so that the first active material layer 112 faces a second active material layer 122 with a separator 107 therebetween.

From one side of each first collector sheet 111 extends a first tab 114 cut out of the same electroconductive sheet material as the first collector sheet 111. The first tabs 114 of the pair of first electrodes 110 are attached together and electrically coupled, for example by welding, forming a tab assembly 114A. To the tab assembly 114A is connected a first lead 113, and the first lead 113 extends out of the sheath 108.

Likewise, from one side of the second collector sheet 121 extends a second tab 124 cut out of the same electroconductive sheet as the second collector sheet 121. To the second tab 124 is connected a second lead 123, and the second lead 123 extends out of the sheath 108.

The ends of the first leads 113 and second lead 123, guided to the outside of the sheath 108, each function as a contact of a positive or negative electrode. A sealant 130 is desirably interposed between the sheath 108 and each lead to improve hermeticity. The sealant 130 can be a thermoplastic resin.

FIGS. 3 and 4 represent only an example of a flexible battery, and the illustrated example does not limit the shape and structure, the number of positive and negative electrodes in the electrode assembly, or any other feature of the flexible battery. However, the shape of the electrode assembly is preferably rectangular or substantially rectangular to ensure productivity and suitability for the intended use. When the electrode assembly is rectangular or substantially rectangular, the ratio of the length of the long sides (major length) to that of the short sides (minor length), major length:minor length, is preferably between 1.2:1 and 8:1. The direction of the long sides is desirably aligned to be substantially parallel to the first direction of the film material forming the sheath, and the angle between the direction of the long sides and the first direction is desirably 0° or more and 30° or less (preferably 10° or less). This naturally results in the length L1 of the sheath in the first direction (direction of arrow D1 in the drawings) being longer than the length L2 of the sheath in the second direction. Setting the length L1 of the sheath in the first direction longer than the length L2 of the sheath in the second direction ensures that the battery deforms more greatly in the first direction when it is deformed, helping prevent the gas barrier layer from cracking during battery deformations.

Strictly speaking, the length of the long sides of the electrode assembly usually corresponds to the longitudinal length of the separators as a component of the electrode assembly, and that of the short sides of the electrode assembly corresponds to the lateral length of the separators as a component of the electrode assembly.

Any method can be used to produce the flexible battery 100, but an example is the following procedure. First, a strip of film material is prepared, the strip of film material is folded into two with the seal layer inside, and the edges of the film material are attached and melt-bonded together to form a tube. The electrode assembly is then inserted from one opening of the tube, and this opening is closed by hot melt bonding. This gives an envelope- or bag-shaped sheath 108. Before the hot melt bonding, the ends of the first lead 113 and second lead 123 are guided out through one opening of the tube, and a sealant 130 is interposed between the end of the opening and each lead. An electrolyte is then injected through the remaining opening of the sheath 108, and this opening is closed by hot melt bonding in a reduced-pressure atmosphere, completing the flexible battery.

The following describes essential features, electrolyte, and other components of the electrode assembly for a lithium-ion secondary battery as an example of a flexible battery.

### (Negative Electrode)

The negative electrode includes a negative electrode collector sheet as a first or second collector sheet and a negative electrode active material layer as a first or second active material layer. The negative electrode collector sheet is a metal film, foil, or the like. The negative electrode collector sheet is preferably made of at least one selected from the group consisting of copper, nickel, titanium, alloys thereof, and stainless steel. The thickness of the negative electrode collector sheet is preferably between 5 and 30 μm, for example.

The negative electrode active material layer contains a negative electrode active material, optionally with a binder and an electroconductive agent. The negative electrode active material layer may be a deposited film formed by gas-phase deposition (e.g., vapor deposition). Examples of negative electrode active materials include metallic Li, metals or alloys that electrochemically react with Li, carbon materials (e.g., graphite), silicon alloys, and silicon oxides. The thickness of the negative electrode active material layer is preferably between 1 and 300 μm, for example.

### (Positive Electrode)

The positive electrode has a positive electrode collector sheet as a first or second collector sheet and a positive electrode active material layer as a first or second active material layer. The positive electrode collector sheet is a metal film, foil, or the like. The positive electrode collector sheet is preferably made of at least one selected from the group consisting of silver, nickel, palladium, gold, platinum, aluminum, alloys thereof, and stainless steel. The thickness of the positive electrode collector sheet is preferably between 1 and 30 μm, for example.

The positive electrode active material layer contains a positive electrode active material and a binder, optionally with an electroconductive agent. Any kind of positive electrode active material can be used, but some examples are lithium composite oxides, such as LiCoO₂ and LiNiO₂. The thickness of the positive electrode active material layer is preferably between 1 and 300 μm, for example.

The electroconductive agent contained in the active material layers is graphite, carbon black, or the like. The amount of the electroconductive agent is, for example, between 0 and 20 parts by mass per 100 parts by mass of active material. The binder contained in the active material layers is a fluoropolymer, acrylic resin, rubber particles, or the like. The amount of the binder is, for example, between 0.5 and 15 parts by mass per 100 parts by mass of active material.

### (Separator)

The separator is preferably a plastic microporous film or nonwoven fabric. The material (resin) for the separator is preferably a polyolefin, a polyamide, a polyamideimide, or the like. The thickness of the separator is, for example, between 8 and 30 μm.

### (Electrolyte)

A nonaqueous electrolyte is preferred that contains a lithium salt and a nonaqueous solvent for dissolving the lithium salt. Examples of lithium salts include LiClO₄, LiBF₄, LiPF₆, LiCF₃SO₃, LiCF₃CO₂, and imide salts. Examples of nonaqueous solvents include cyclic carbonates, such as propylene carbonate, ethylene carbonate, and butylene carbonate, linear carbonates, such as diethyl carbonate, ethyl methyl carbonate, and dimethyl carbonate, and cyclic carboxylates, such as γ-butyrolactone and γ-valerolactone.

At least part of the nonaqueous electrolyte impregnating the electrode assembly is preferably in the form of gel electrolyte. The gel electrolyte contains, for example, the nonaqueous electrolyte and a resin that swells with the nonaqueous electrolyte. The resin that swells with the nonaqueous electrolyte is preferably a fluoropolymer having vinylidene fluoride units. Fluoropolymers having vinylidene fluoride units easily hold a nonaqueous electrolyte inside and therefore easily gel.

The following describes the present invention in further detail on the basis of Examples. It should be noted that the following Examples do not limit the present invention.

### Example 1

A flexible battery having a pair of negative electrodes and a positive electrode interposed therebetween was fabricated through the following procedure.

### (1) Fabrication of the Negative Electrodes

An 8-μm thick electrolytic copper foil was prepared as a negative electrode collector sheet. A negative electrode mixture slurry was applied to one side of the electrolytic copper foil, dried, and then rolled to form a negative electrode active material layer, giving a negative electrode sheet. The negative electrode mixture slurry was prepared by mixing 100 parts by mass of graphite (22 μm in average particle diameter) as a negative electrode active material, 8 parts by mass of polyvinylidene fluoride as a binder, and an appropriate amount of N-methyl-2-pyrrolidone (NMP). The thickness of the negative electrode active material layer was 145 μm. From the negative electrode sheet were cut out 23 mm×55 mm negative electrodes having a 5 mm×5 mm negative electrode tab, and the active material layer was peeled off the negative electrode tab to expose copper foil. A copper negative electrode lead was then ultrasonically welded to the tip of the negative electrode tab.

### (2) Fabrication of the Positive Electrode

A 15-μm thick aluminum foil was prepared as a positive electrode collector sheet. A positive electrode mixture slurry was applied to both sides of the aluminum foil, dried, and then rolled to form positive electrode active material layers, giving a positive electrode sheet. The positive electrode mixture slurry was prepared by mixing 100 parts by mass of LiNi_{0.8}CO_{0.16}Al_{0.04}O₂ (20 μm in average particle diameter) as a positive electrode active material, 0.75 parts by mass of acetylene black as an electroconductive agent, 0.75 parts by mass of polyvinylidene fluoride as a binder, and an appropriate amount of NMP. The thickness of the positive electrode active material layers per side was 80 μm. From the positive electrode sheet was cut out a 21 mm×53 mm positive electrode having a 5 mm×5 mm tab, and the active material layers were peeled off the positive electrode tab to expose aluminum foil. An aluminum positive electrode lead was then ultrasonically welded to the tip of the positive electrode tab.

### (3) Nonaqueous Electrolyte

A nonaqueous electrolyte was prepared by dissolving LiPF₆ in a mixture of ethylene carbonate (EC), ethyl methyl carbonate (EMC), and diethyl carbonate (DEC) (ratio of 20:30:50 by volume) to a concentration of 1 mol/L.

### (4) Fabrication of the Sheath

A biaxially oriented PE film (15 μm thick), to serve as the seal layer, was covered on one side with a 100-μm thick rolled tin alloy foil (Sn, 98.5% by mass; Bi, 1.5% by mass), which was to serve as the gas barrier layer. The exposed side of the rolled tin alloy foil was covered with a PE film (25 μm thick), to serve as a protective layer, with an adhesive layer therebetween. The resulting stack was pressed while being heated at 130° C., with the direction of rolling of the rolled tin alloy foil aligned with the MD direction of the biaxially oriented PE film to serve as the seal layer. In this way, a three-layer film material (140 μm thick) for battery sheathing was prepared.

The first direction of the resulting film material coincided with the direction of rolling of the tin alloy foil.

The film material had a tensile strength A of 8.4 N/mm² at 5% elongation in the first direction and a tensile strength B of 13.0 N/mm² at 5% elongation in the second direction (A/B=0.65).

The tin alloy foil had a tensile strength X of 8.6 N/mm² at 5% elongation in the first direction and a tensile strength Y of 15 N/mm² at 5% elongation in the second direction (X/Y=0.57).

### (5) Assembly of the Flexible Battery

Five parts by mass of polyvinylidene fluoride was dissolved in 100 parts by mass of the solvent mixture to give a polymer solution. The polymer solution was applied to both sides of 23 mm×59 mm separators (9 μm thick) made from a microporous polyethylene film, and then the solvent was evaporated to form coatings of polyvinylidene fluoride. The amount of polyvinylidene fluoride applied was 15 g/m². Then the positive electrode was placed between the pair of negative electrode active material layers with the separators therebetween, forming an electrode assembly. The electrode assembly therefore has a major length of 59 mm and a minor length of 23 mm.

Then, from the film material, a 60 mm×70 mm sheet was cut out, with two opposite sides of the sheet aligned with the first direction and the other opposite two perpendicular to the first direction. The sheet was then folded in two to form a 30 mm×70 mm bag, with the seal layer inside and making a fold parallel to the first direction. The positive electrode and negative electrode leads were guided out through one opening of the bag, each lead was wrapped with a thermoplastic resin to as a sealant, and the opening was closed hermetically by hot melt bonding. The nonaqueous electrolyte was then injected through the other opening, and this opening was hot-melt bonded in a reduced-pressure atmosphere of −650 mmHg. The battery was then aged at 45° C. to impregnate the electrode assembly with the nonaqueous electrolyte. Lastly, the battery was pressed with a pressure of 0.25 MPa for 30 seconds at 25° C. In this way, 0.5-mm thick battery A1 was fabricated.

### Comparative Example 1

In the cutting of a 60 mm×70 mm sheet out from the film material, the cutting directions were changed by 90°, and in the folding of the sheet in two with the seal layer inside to form a 30 mm×70 mm bag, the fold was made perpendicular to the first direction. Except for these, the same procedure as in Example 1 was followed to fabricate battery B1.

### Examples 2 to 8 and Comparative Example 2

The rolling reduction of the rolled tin alloy foil was changed to give film materials in which the first direction of the film material was aligned with the direction of rolling of the tin alloy foil and that varied in the tensile strengths A and B of the film material and the tensile strengths X and Y of the tin alloy foil as presented in Table 1. Using these materials, batteries A2 to A8 and B2 were fabricated in the same way as in Example 1.

TABLE 1

| | X | Y | A | B | | |
|---|---|---|---|---|---|---|
| | (N/mm²) | (N/mm²) | (N/mm²) | (N/mm²) | X/Y | A/B |
| A1 | 8.6 | 15.0 | 8.4 | 13.0 | 0.57 | 0.65 |
| A2 | 1.4 | 15.0 | 3.3 | 13.0 | 0.09 | 0.25 |
| A3 | 5.9 | 15.0 | 6.5 | 13.0 | 0.39 | 0.50 |
| A4 | 10.5 | 15.0 | 9.8 | 13.0 | 0.70 | 0.75 |
| A5 | 11.8 | 15.0 | 10.6 | 13.0 | 0.79 | 0.82 |
| A6 | 24.8 | 35.0 | 20.0 | 27.3 | 0.71 | 0.73 |
| B1 | 8.6 | 15.0 | 8.4 | 13.0 | 0.57 | 0.65 |
| A7 | 12.5 | 15.0 | 11.2 | 13.0 | 0.83 | 0.86 |
| A8 | 14.0 | 15.0 | 12.3 | 13.0 | 0.93 | 0.95 |
| B2 | 14.4 | 15.0 | 12.6 | 13.0 | 0.96 | 0.97 |

### Examples 9 to 14

Batteries A9 to A14 were fabricated in the same way as in Example 1, except that the thickness of the rolled tin alloy foil (T₀) was changed as presented in Table 2.

TABLE 2

| | T₀ | X | Y | A | B | | |
|---|---|---|---|---|---|---|---|
| | (μm) | (N/mm²) | (N/mm²) | (N/mm²) | (N/mm²) | X/Y | A/B |
| A9 | 15 | 8.6 | 15.0 | 8.1 | 9.9 | 0.57 | 0.82 |
| A10 | 30 | 8.6 | 15.0 | 8.3 | 11.0 | 0.57 | 0.75 |
| A11 | 40 | 8.6 | 15.0 | 8.3 | 11.5 | 0.57 | 0.72 |
| A12 | 60 | 8.6 | 15.0 | 8.4 | 12.2 | 0.57 | 0.69 |
| A13 | 85 | 8.6 | 15.0 | 8.4 | 12.7 | 0.57 | 0.66 |
| A14 | 150 | 8.6 | 15.0 | 8.5 | 13.5 | 0.57 | 0.63 |

### Examples 15 to 17

Batteries A15 to A17 were fabricated in the same way as in Example 1, except that the rolled tin alloy foil was changed to aluminum foil (20 μm thick), rolled indium alloy foil (In, 95% by mass; Zn, 5% by mass) (50 μm thick), or rolled magnesium alloy foil (Mg, 98.5% by mass; In, 1.5% by mass) (20 μm thick).

TABLE 3

| | Foil | X | Y | A | B | | |
|---|---|---|---|---|---|---|---|
| | type | (N/mm²) | (N/mm²) | (N/mm²) | (N/mm²) | X/Y | A/B |
| A15 | Al | 15.0 | 26.0 | 20.0 | 28.0 | 0.58 | 0.71 |
| A16 | In alloy | 6.0 | 10.0 | 1.8 | 3.0 | 0.60 | 0.60 |
| A17 | Mg alloy | 12.0 | 21.0 | 19.0 | 25.0 | 0.57 | 0.76 |

### Example 18

The rolled tin alloy foil was immersed in a chromate treatment solution containing a trivalent chromate to form a 0.2-μm thick chromium oxide layer. Except for the use of a rolled tin alloy foil having a chromium oxide layer, the same procedure as in Example 1 was followed to fabricate battery A18.

TABLE 4

| | Foil | X | Y | A | B | | |
|---|---|---|---|---|---|---|---|
| | type | (N/mm²) | (N/mm²) | (N/mm²) | (N/mm²) | X/Y | A/B |
| A18 | Sn/CrO | 8.6 | 15.0 | 8.4 | 13.0 | 0.57 | 0.65 |

### Example 19

Battery A19 was fabricated in the same way as in Example 1, except that the MD direction of the seal layer was set perpendicular to the first direction. The first direction of the film material still coincided with the direction of rolling of the tin alloy foil.

TABLE 5

| | X | Y | A | B | | |
|---|---|---|---|---|---|---|
| | (N/mm²) | (N/mm²) | (N/mm²) | (N/mm²) | X/Y | A/B |
| A19 | 8.6 | 15.0 | 8.8 | 12.7 | 0.57 | 0.69 |

### Example 20

Battery A20 was fabricated in the same way as in Example 1, except that the MD direction of the protective layer was set perpendicular to the first direction. The first direction of the film material still coincided with the direction of rolling of the tin alloy foil.

TABLE 6

| | X | Y | A | B | | |
|---|---|---|---|---|---|---|
| | (N/mm²) | (N/mm²) | (N/mm²) | (N/mm²) | X/Y | A/B |
| A20 | 8.6 | 15.0 | 8.6 | 12.7 | 0.6 | 0.7 |

### Example 21

Battery A21 was fabricated in the same way as in Example 1, except that the MD direction of both seal and protective layers was set perpendicular to the first direction. The first direction of the film material still coincided with the direction of rolling of the tin alloy foil.

TABLE 7

| | X | Y | A | B | | |
|---|---|---|---|---|---|---|
| | (N/mm²) | (N/mm²) | (N/mm²) | (N/mm²) | X/Y | A/B |
| A21 | 8.6 | 15.0 | 8.8 | 12.5 | 0.57 | 0.70 |

### Examples 22 and 23

Batteries A22 and A23 were fabricated in the same way as in Example 1, except that the protective layer was polyethylene terephthalate (PET) or polyamide 6.

TABLE 8

| | X | Y | A | B | | |
|---|---|---|---|---|---|---|
| | (N/mm²) | (N/mm²) | (N/mm²) | (N/mm²) | X/Y | A/B |
| A22 | 8.6 | 15.0 | 10.8 | 15.3 | 0.57 | 0.70 |
| A23 | 8.6 | 15.0 | 9.0 | 13.5 | 0.65 | 0.66 |

### [Testing]

### (Initial Battery Capacity)

The initial capacity (C₀) of each battery was determined by charging and discharging the battery as follows at 25° C.

The design capacity of battery A is defined as 1 C (mAh).

(1) Constant-current charging: 0.2 CmA (cut-off voltage, 4.2 V)

(2) Constant-voltage charging: 4.2 V (cut-off current, 0.05 CmA)

(3) Constant-current discharging: 0.5 CmA (cut-off voltage, 2.5 V)

### (Durability of the Gas Barrier Layer)

A pair of telescopic fasteners were arranged horizontally to face each other, and the closed portions of the charged battery, located at both ends and closed by hot melt bonding, were fastened with the fasteners. Then at a humidity of 65% and 25° C., a jig having a curved portion with a radius of curvature R of 20 mm was pushed against the battery to bend the battery along the curved portion, and then released to allow the battery to return to its original shape. This operation was repeated 4000 times. The discharge capacity after the bending test (Cₓ) was then determined by charging and discharging the battery under the same conditions as above. From the obtained discharge capacity Cₓ and the initial capacity C₀, the percentage capacity retention was determined according to the equation below.

Capacity retention after the bending test (%)=(Cₓ/C₀)×100

For each of Examples and Comparative Examples, ten batteries were fabricated and tested in the same way to determine the mean percentage capacity retention. The results are presented in Table 9.

TABLE 9

| Battery | Initial capacity (mAh) | Capacity retention (%) |
|---|---|---|
| A1 | 110 | 98 |
| A2 | 110 | 95 |
| A3 | 110 | 95 |
| A4 | 110 | 92 |
| A5 | 110 | 88 |
| A6 | 110 | 87 |
| B1 | 110 | 59 |
| A7 | 110 | 68 |
| A8 | 110 | 66 |
| B2 | 110 | 59 |
| A9 | 110 | 95 |
| A10 | 110 | 96 |
| A11 | 110 | 94 |
| A12 | 110 | 93 |
| A13 | 110 | 93 |
| A14 | 110 | 89 |
| A15 | 110 | 94 |
| A16 | 110 | 93 |
| A17 | 110 | 94 |
| A18 | 110 | 96 |
| A19 | 110 | 91 |
| A20 | 110 | 91 |
| A21 | 110 | 89 |
| A22 | 110 | 85 |
| A23 | 110 | 86 |

Once the gas barrier layer cracks, water enters the battery because of reduced gas barrier capability. As a result, the percentage capacity retention decreases. The batteries of Comparative Examples had lower percentage capacity retentions, suggesting that the gas barrier layer became damaged. By contrast, the batteries of Examples, satisfying A/B≤0.82, all achieved a good percentage capacity retention.

### INDUSTRIAL APPLICABILITY

The film materials according to the present invention for battery sheathing are suitable for use as a sheath for flexible batteries that are employed as a power supply for small electronic devices such as on-body devices and wearable devices and therefore can be deformed greatly.

### REFERENCE SIGNS LIST

10A, 10B Film material
11A, 11B Gas barrier layer
11x Metal layer
12 Seal layer
13 Protective layer
14 Metal oxide layer
100 Flexible battery
103 Electrode assembly
107 Separator
108 Sheath
110 First electrode
111 First collector sheet
112 First active material layer
113 First lead
114 First tab
114A Tab assembly
120 Second electrode
121 Second collector sheet
122 Second active material layer
123 Second lead
124 Second tab
130 Sealant

1. A film material for battery sheathing, the film material comprising:
a gas barrier layer; and
a seal layer superposed on one side of the gas barrier layer and containing a first resin; wherein:
the film material has anisotropic tensile strength; and
a tensile strength A at 5% elongation in a first direction, in which the film material has a smallest tensile strength, and
a tensile strength B at 5% elongation in a second direction, perpendicular to the first direction, satisfy
A/B≤0.95.

2. The film material according to claim 1 for battery sheathing, wherein
0.25≤A/B is satisfied.

3. The film material according to claim 1 for battery sheathing, wherein
A is 25 N/mm² or less.

4. The film material according to claim 1 for battery sheathing, wherein:
a tensile strength X of the gas barrier layer at 5% elongation in the first direction and
a tensile strength Y of the gas barrier layer at 5% elongation in the second direction satisfy X/Y≤0.93.

5. The film material according to claim 1 for battery sheathing, wherein:
the seal layer is a biaxially oriented resin film; and
an angle between an MD direction of the seal layer and the first direction is 0° or more and 30° or less.

6. The film material according to claim 1 for battery sheathing, further comprising
a protective layer superposed on the other side of the gas barrier layer and containing a second resin, wherein
the second resin is polyethylene.

7. The film material according to claim 6 for battery sheathing, wherein:
the protective layer is a biaxially oriented resin film; and
an angle between an MD direction of the protective layer and the first direction is 0° or more and 30° or less.

8. The film material according to claim 1 for battery sheathing, wherein the gas barrier layer includes a metal layer.

9. The film material according to claim 8 for battery sheathing, wherein the metal layer contains at least one selected from the group consisting of aluminum, tin, indium, and magnesium.

10. The film material according to claim 8 for battery sheathing, wherein:
the metal layer includes rolled foil; and
the first direction is a direction of rolling of the rolled foil.

11. The film material according to claim 1 for battery sheathing, wherein a thickness of the gas barrier layer is 10 μm or more and 100 μm or less.

12. A flexible battery comprising:
an electrode assembly including a positive electrode, a negative electrode, and an electrolyte layer interposed between the positive and negative electrodes; and
a sheath enclosing the electrode assembly hermetically, wherein
the sheath includes a film material according to claim 1 for battery sheathing.

13. The flexible battery according to claim 12, wherein:
the electrode assembly is a sheet-shaped multilayer body in which the positive electrode, negative electrode, and electrolyte layer are stacked each in a shape of a sheet; and
a length L1 of the sheath in the first direction is longer than a length L2 of the sheath in the second direction.

14. The flexible battery according to claim 12, wherein a total thickness of the electrode assembly and the sheath is 2 mm or less.
